(19) United States
(12) Patent Application Publication
(10) Pub. No.: US 2026/0159065 A1
(43) Pub. Date: Jun. 11, 2026

(54) APPARATUS AND METHOD FOR CONTROLLING A POWER GENERATION MODE OF A HYBRID ELECTRIC VEHICLE

(71) Applicants: HYUNDAI MOTOR COMPANY, Seoul (KR); KIA CORPORATION, Seoul (KR)

(72) Inventors: Jee Wook Huh, Hwaseong-si (KR); Dong Su Ha, Hwaseong-si (KR)

(73) Assignees: HYUNDAI MOTOR COMPANY, Seoul (KR); KIA CORPORATION, Seoul (KR)

(21) Appl. No.: 19/217,297

(22) Filed: May 23, 2025

(30) Foreign Application Priority Data
Dec. 9, 2024 (KR) 10-2024-0181724

(51) Int. Cl. B60W 20/13; B60W 10/06; B60W 10/26; B60W 10/30; B60W 30/182; B60W 30/188; B60W 30/20

(52) U.S. Cl. CPC B60W 20/13; B60W 10/06; B60W 10/26; B60W 10/30; B60W 30/182; B60W 30/1882; B60W 30/1886; B60W 30/20; B60W 2030/206; B60W 2510/08; B60W 2510/244; B60W 2510/305; B60W 2540/215; B60W 2710/0677

(57) ABSTRACT

An apparatus and a method for controlling a power generation mode of a hybrid electric vehicle (HEV) are disclosed. The apparatus includes an input device that receives a setting of the power generation mode of an engine from a user. The apparatus includes a controller that supplies power to an alternating current (AC) outlet and controls an engine control unit (ECU) to operate the engine of the hybrid electric vehicle (HEV) in the set power generation mode when a state of charge (SOC) of a battery does not exceed a threshold value. Therefore, it is possible to provide various power generation modes that satisfy the needs of a user and increase the operating efficiency of an engine to prevent unnecessary waste of energy.

### CROSS-REFERENCE TO RELATED APPLICATION

This application claims the benefit of and priority to Korean Patent Application No. 10-2024-0181724, filed in the Korean Intellectual Property Office on Dec. 9, 2024, the entire contents of which are incorporated herein by reference.

### TECHNICAL FIELD

The present disclosure relates to a technology for controlling a power generation mode for supplying electric power to an alternating current (AC) outlet equipped in a type of hybrid electric vehicle (HEV) with a transmission mounted electric device (TMED).

### BACKGROUND

Generally, a hybrid vehicle refers to a vehicle that operates by efficiently combining two or more different types of power sources. However, in most cases, a hybrid vehicle refers to a vehicle equipped with an engine that obtains driving power by burning fossil fuels and an electric motor that obtains driving power using power from a battery.

Such hybrid vehicles may be configured in various structures using engines and electric motors as power sources. A parallel hybrid vehicle may transmit the mechanical power of the engine directly to wheels, with assistance from an electric motor driven by electricity from a battery when needed. A series hybrid vehicle may convert the mechanical power of an engine into electrical power to drive an electric motor or charge a battery. Therefore, the parallel hybrid vehicle is advantageous for high-speed driving or long-distance driving, and the series hybrid vehicle is advantageous for city driving or short-distance driving.

A plug-in hybrid electric vehicle (PHEV) has been developed. The PHEV has a larger battery capacity than that of an HEV and charges the battery from an external power source. The PHEV is driven only in an EV mode for short distances and is driven in an HEV mode when the battery is depleted. Like the HEV, the PHEV may be equipped with both a gasoline-powered engine and a battery-powered motor. This configuration allows the PHEV to be powered by either or both. The PHEV may also be equipped with a high-voltage battery of a large-capacity that is be charged with external electricity.

Such a hybrid vehicle has an engine and a drive motor directly connected with each other as a driving source. The hybrid vehicle includes a clutch and transmission for power transmission, an inverter for driving the engine and drive motor, a high-voltage battery, and the like. In addition, the hybrid vehicle includes a hybrid control unit (HCU), a motor control unit (MCU), and a battery control unit (BCU) or battery management system (BMS) that are connected to each other such that they communicate with each other through controller area network (CAN) communication as control devices. In particular, a transmission mounted electric device (TMED) type HEV includes the motor mounted on the transmission side and includes an engine clutch provided between the motor and the engine. The TMED type HEV may transmit the power of the engine to the driving system through the drive motor by engaging the engine clutch.

Recently, as the number of people enjoying leisure activities such as camping and car camping increases, vehicle to load (V2L) technology has been developed to enable the use of vehicle battery power for leisure purposes.

The V2L technology refers to the technology that converts the high-voltage direct current (DC) of a high-voltage battery installed in an EV or PHEV into low-voltage alternating current (AC) that may be used in general household appliances. Thus, the electric energy of the battery is used externally. The V2L technology supplies the low-voltage AC to an AC outlet installed inside the vehicle and/or an AC outlet installed outside the vehicle.

In the case of EVs and PHEVs, the V2L technology may supply power of 2 to 4 KW, which is sufficient to operate devices used in general households and may also use up to 80% of the maximum capacity of the battery. However, an HEV is equipped with a high-voltage battery having a relatively small capacity compared to an EV or a PHEV. Thus, the high-voltage battery of the HEV may not supply sufficient power, and the time for which power is supplied may also be limited.

The V2L control technology of a conventional TMED HEV supplies AC voltage when the state of charge (SOC) of a battery is equal to or greater than a set value. The V2L control technology of the conventional TMED HEV operates an engine to charge the battery when the SOC is less than the set value.

Such a conventional technology operates the engine in a simple manner and does not provide various power generation modes that meet the needs of users.

The matters described in this background section are intended to promote an understanding of the background of the present disclosure and may include matters that are not already known to those having ordinary skill in the art.

### SUMMARY

The present disclosure has been made to solve the above-mentioned problems occurring in the prior art while advantages achieved by the prior art are maintained intact.

One aspect of the present disclosure provides an apparatus and a method for controlling a power generation mode of a hybrid electric vehicle (HEV). The apparatus and the method may not only provide various power generation modes that may satisfy the needs of a user, but also increase the operating efficiency of an engine to prevent unnecessary waste of energy. To this end, the apparatus and the method may receive a setting of an engine power generation mode from a user, may supply power to an alternating current (AC) outlet, and may control an engine control unit (ECU) to operate the engine of a hybrid electric vehicle (HEV) in the set power generation mode when a state of charge (SOC) of a battery does not exceed a threshold value.

Another aspect of the present disclosure provides an apparatus and a method for controlling a power generation mode of an HEV. The apparatus and the method may increase the operating efficiency of an engine to prevent unnecessary waste of energy. To this end, the apparatus and the method may include a brake specific fuel consumption (BSFC) map indicating an optimal operating line (OOL) of the engine. The apparatus and the method may determine the efficiency of a converter, the efficiency of a battery, the efficiency of a motor, the required power of an AC outlet, the required power of the AC outlet considering (or based on) the efficiency of the converter, and an amount of power corresponding to an SOC of the battery. The apparatus and the method may determine an operating point of the engine based on the deviation from the required power of the AC outlet when the SOC of the battery is below a threshold value. The apparatus and the method may determine the operating point of the engine based on the OOL when the SOC of the battery exceeds the threshold and a reference operating point is located at the lower end of the OOL on the BSFC map. The apparatus and the method may determine the reference operating point as the operating point of the engine when the reference operating point is located at the top of the OOL on the BSFC map.

Still another aspect of the present disclosure provides an apparatus a method for controlling a power generation mode of an HEV. The apparatus and the method may increase the operating efficiency of an engine to prevent unnecessary waste of energy. To this end, the apparatus and the method may include a brake specific fuel consumption (BSFC) map indicating an optimal operating line (OOL) of the engine. The apparatus and the method may determine the efficiency of a converter, the efficiency of a battery, the efficiency of a motor, the efficiency (d1) of the engine corresponding to an amount of fuel on the OOL, the required power (γ) of the AC outlet considering (or based on) the efficiency of the converter, the efficiency (d2) of the engine corresponding to the amount of fuel required to output γ, a chargeable energy amount (ξ) of the battery, the maximum efficiency (F) considering (or based on) ξ, and the partial efficiency (G) considering (or based on) γ. The apparatus and the method may determine the operating point of the engine based on d1 on the BSFC map when F>G. The apparatus and the method may determine the operating point of the engine based on d2 on the BSFC map when F<G.

Still another aspect of the present disclosure provides an apparatus and a method for controlling a power generation mode of an HEV. The apparatus and the method may increase the operating efficiency of an engine to prevent unnecessary waste of energy. To this end, the apparatus and the method may include a BSFC map in which a noise, vibration, harshness (NVH) optimal operating point is displayed on an OOL of the engine. The apparatus and the method may determine the NVH optimal operating point of the engine as the operating point when a user sets the power generation mode of the engine to a low-noise mode. The apparatus and the method may determine the required power (γ) of the AC outlet based on the efficiency of a converter when the SOC of the battery is below the lower limit (e.g., 20%). The apparatus and the method may determine the operating point of the engine as the operating point with the best (i.e., highest) efficiency among the engine outputs corresponding to γ.

Still another aspect of the present disclosure provides an apparatus and a method for controlling a power generation mode of an HEV. The apparatus and the method may increase the operating efficiency of an engine to prevent unnecessary waste of energy. To this end, the apparatus and the method may include a BSFC map indicating an OOL of the engine. The apparatus and the method may determine the efficiency of a converter, the efficiency of a battery, the efficiency of a motor, the required power of an AC outlet, and AC maximum capacity (θ). The apparatus and the method may determine the operating point of the engine for maximum power generation when a user sets the power generation mode of the engine to a maximum mode. The apparatus and the method may determine a first operating point as the operating point of the engine when a first condition is satisfied considering (or based on) the chargeable power of the motor. The apparatus and the method may determine a second operating point as the operating point of the engine when a second condition is satisfied considering (or based on) the chargeable power (λ) of the battery.

The technical problems to be solved by the present disclosure are not limited to the aforementioned problems. Any other technical problems not mentioned herein should be clearly understood from the following description by those having ordinary skill in the art to which the present disclosure pertains. Also, it may be easily understood that the objects and advantages of the present disclosure may be realized by the units and combinations thereof recited in the claims.

According to one aspect of the present disclosure, an apparatus for controlling a power generation mode of a hybrid electric vehicle (HEV) includes an input device that receives a setting of the power generation mode of an engine from a user. The apparatus further includes a converter that converts direct current (DC) power of a battery into alternating current (AC) power. The apparatus further includes a controller that supplies the AC power to an AC outlet provided in the HEV and controls an engine control unit (ECU) to operate the engine in the set power generation mode when a state of charge (SOC) of a battery does not exceed a first threshold value.

According to an embodiment, the input device may receive a setting of one of an automatic mode, an optimum mode, a low noise mode, or a maximum mode as the power generation mode.

According to an embodiment, the controller may determine an operating point of the engine based on an efficiency of the converter, an efficiency of the battery, an efficiency of a motor directly connected to the engine, a required power of the AC outlet, a required power of the AC outlet reflecting the efficiency of the converter, and an amount of power corresponding to the SOC of the battery when the SOC of the battery does not exceed the first threshold value.

According to an embodiment, the controller may determine an operating point of the engine based on an efficiency of the converter, an efficiency of the battery, an efficiency of a motor directly connected to the engine, and a required power of the AC outlet reflecting the efficiency of the converter when the SOC of the battery exceeds the first threshold value due to an operation of the engine. The controller may stop the operation of the engine when the SOC of the battery exceeds a second threshold value due to the operation of the engine.

According to an embodiment, the controller may determine a maximum efficiency based on a chargeable energy amount of the battery. The controller may determine a partial efficiency based on a required power of the AC outlet. In the AC outlet, an efficiency of the converter is reflected. The controller may determine an operating point of the engine based on a brake specific fuel consumption (BSFC) map indicating an optimal operating line (OOL) of the engine when the maximum efficiency exceeds the partial efficiency. The controller may determine the operating point of the engine based on an efficiency of the engine corresponding to an amount of fuel required to output the required power of the AC outlet, when the maximum efficiency does not exceed the partial efficiency.

According to an embodiment, the controller may determine an operating point of the engine based on a brake specific fuel consumption (BSFC) map indicating an optimal operating line (OOL) and a noise, vibration, harshness (NVH) optimal operating point of the engine.

According to an embodiment, the controller may determine a required power of the AC outlet based on an efficiency of the converter when the SOC of the battery reaches a low limit value. The controller may determine an operating point having a best (i.e., highest) efficiency among engine outputs corresponding to the required power as the operating point of the engine.

According to an embodiment, the controller may determine an operating point of the engine based on an efficiency of the converter, an efficiency of the battery, an efficiency of a motor directly connected to the engine, and a maximum amount of power supplied to the AC outlet when the maximum mode is set as the power generation mode.

According to an embodiment, the controller may determine an operating point of the engine based on a chargeable power and an efficiency of a motor directly connected to the engine when the maximum mode is set as the power generation mode.

According to an embodiment, the controller may determine an operating point of the engine based on a charging power and an efficiency of the battery, an efficiency of a motor directly connected to the engine, and a required power of the AC outlet when the maximum mode is set as the power generation mode.

According to another aspect of the present disclosure, a method of controlling a power generation mode of a hybrid electric vehicle (HEV) includes receiving, by an input device, a setting of the power generation mode of an engine from a user. The method further includes converting, by a converter, direct current (DC) power of a battery into alternating current (AC) power. The method further includes supplying, by a controller, the AC power to an AC outlet provided in the HEV. The method further includes controlling, by the controller, an engine control unit (ECU) to operate the engine in the set power generation mode when a state of charge (SOC) of a battery does not exceed a first threshold value.

According to an embodiment, receiving the setting of the power generation mode of the engine may include receiving a setting of one of an automatic mode, an optimum mode, a low noise mode, or a maximum mode.

According to an embodiment, controlling the ECU may include determining an operating point of the engine based on an efficiency of the converter, an efficiency of the battery, an efficiency of a motor directly connected to the engine, a required power of the AC outlet, a required power of the AC outlet reflecting the efficiency of the converter, and an amount of power corresponding to the Soc of the battery when the SOC of the battery does not exceed the first threshold value.

According to an embodiment, controlling the ECU may include determining an operating point of the engine based on an efficiency of the converter, an efficiency of the battery, an efficiency of a motor directly connected to the engine, and a required power of the AC outlet reflecting the efficiency of the converter when the SOC of the battery exceeds the first threshold value due to an operation of the engine. Controlling the ECU may further include stopping the operation of the engine when the SOC of the battery exceeds a second threshold value due to the operation of the engine.

According to an embodiment, controlling the ECU may include determining a maximum efficiency based on a chargeable energy amount of the battery. Controlling the ECU may further include determining a partial efficiency based on a required power of the AC outlet. In the AC outlet, an efficiency of the converter is reflected. Controlling the ECU may further include determining an operating point of the engine based on a brake specific fuel consumption (BSFC) map indicating an optimal operating line (OOL) of the engine when the maximum efficiency exceeds the partial efficiency. Controlling the ECU may further include determining the operating point of the engine based on an efficiency of the engine corresponding to an amount of fuel required to output the required power of the AC outlet, when the maximum efficiency does not exceed the partial efficiency.

According to an embodiment, controlling the ECU may include determining an operating point of the engine based on a brake specific fuel consumption (BSFC) map indicating an optimal operating line (OOL) and a noise, vibration, harshness (NVH) optimal operating point of the engine.

According to an embodiment, controlling the ECU may further include determining a required power of the AC outlet based on an efficiency of the converter when the SOC of the battery reaches a low limit value. Controlling the ECU may further include determining an operating point having a best (i.e., highest) efficiency among engine outputs corresponding to the required power as the operating point of the engine.

According to an embodiment, controlling the ECU may include determining an operating point of the engine based on an efficiency of the converter, an efficiency of the battery, an efficiency of a motor directly connected to the engine, and a maximum amount of power supplied to the AC outlet when the maximum mode is set as the power generation mode.

According to an embodiment, controlling the ECU may include determining an operating point of the engine based on a chargeable power and an efficiency of a motor directly connected to the engine when the maximum mode is set as the power generation mode.

According to an embodiment, controlling the ECU may include determining an operating point of the engine based on a charging power and an efficiency of the battery, an efficiency of a motor directly connected to the engine, and a required power of the AC outlet when the maximum mode is set as the power generation mode.

### BRIEF DESCRIPTION OF THE DRAWINGS

The above and other objects, features, and advantages of the present disclosure should be more apparent from the following detailed description taken in conjunction with the accompanying drawings:

FIG. 1 is a diagram illustrating an example of a transmission mounted electric device (TMED) type HEV to which each embodiment of the present disclosure is applied;

FIG. 2 is a block diagram illustrating the configuration of an apparatus for controlling a power generation mode of a hybrid electric vehicle (HEV) according to an embodiment of the present disclosure;

FIG. 3 is a diagram illustrating an example of a brake specific fuel consumption (BSFC) map of an engine stored in storage inside an apparatus for controlling a power generation mode of an HEV according to an embodiment of the present disclosure;

FIG. 4 is a flowchart illustrating a method of controlling a power generation mode of an HEV according to an embodiment of the present disclosure; and

FIG. 5 is a block diagram illustrating a computing system for executing a method of controlling a power generation mode of an HEV according to each embodiment of the present disclosure.

### DETAILED DESCRIPTION

Hereinafter, some embodiments of the present disclosure are described in detail with reference to the drawings. In adding the reference numerals to the components of each drawing, it should be noted that the identical and equivalent components are designated by the identical numerals even when the components are displayed on other drawings. Further, in describing the embodiment of the present disclosure, a detailed description of the related known configuration or function has been omitted when it is determined that the detailed description interferes with the understanding of the embodiment of the present disclosure.

Terms, such as first, second, A, B, (a), (b) or the like, may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those having ordinary skill in the art to which the present disclosure pertains. The terms defined in the generally used dictionaries should be construed as having the meanings that are consistent with the meanings of the contexts of the related technologies, and should not be construed as ideal or excessively formal meanings unless clearly defined in the present disclosure. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

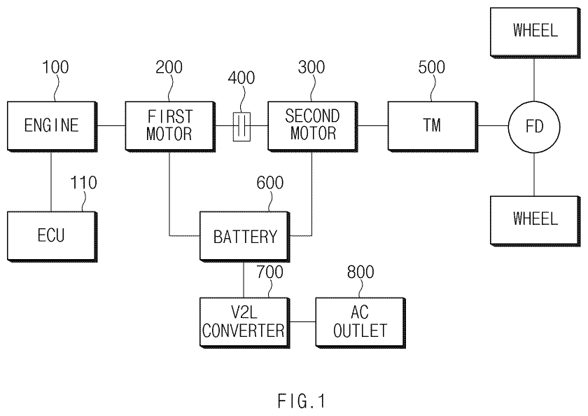

FIG. 1 is a diagram illustrating an example of a transmission mounted electric device (TMED) type hybrid electric vehicle (HEV) to which each embodiment of the present disclosure is applied.

As illustrated in FIG. 1, a TMED type HEV to which each embodiment of the present disclosure is applied may include a parallel type hybrid system. The parallel type hybrid system includes an engine 100, a first motor 200, a second motor 300, and an engine clutch 400, and a transmission 500. The first motor 200, the second motor 300 and the engine clutch 400 are disposed between the engine 100 and the transmission 500. Such a parallel type hybrid system is also called a TMED hybrid system because the second motor 300 is constantly connected to an input end of the transmission 500.

In this case, the first motor 200 may be positioned between the engine 100 and the engine clutch 400. A shaft (engine shaft) of the engine 100 and a first shaft (first motor shaft) of the first motor 200 may be directly connected to each other and may rotate together at all times. One end of the second shaft (second motor shaft) of the second motor 300 may be connected to the engine clutch 400, and an opposite end of the second shaft may be connected to the input end of the transmission 500. In this case, because the second motor 300 may produce greater output than the first motor 200, the second motor 300 may perform a function of a driving motor.

The first motor 200 may perform a function as a starter motor that cranks the engine 100 when the engine 100 is started. The first motor 200 may recover the rotational energy of the engine 100 through power generation when the engine 100 is turned off. The first motor 200 may also generate electric power using the power of the engine 100 when the engine 100 is operated. In addition, in the TMED II type HEV, the first motor 200 is positioned between the output side of the engine 100 and the clutch 400, but in the TMED I type HEV, the first motor 200 is positioned on the input side of the engine 100.

The second motor 300, which is a driving motor that generates power required for driving the vehicle, may assist the power of the engine 100 as needed. In addition, the second motor 300 may optionally operate as a generator to generate electric energy. The second motor 300 may refer to a P2 motor positioned between the clutch 400 and the transmission 500 in a TMED type HEV.

The first motor 200 and the second motor 300 may include a plurality of power switching elements and may include an inverter that converts a direct current (DC) voltage supplied from a battery 600 into a three-phase alternating current voltage.

Power output from the engine 100 and the second motor 300 is transmitted to the driving wheels of the vehicle. In this case, the transmission 500 may be provided between the clutch 400 and the driving wheels.

The clutch 400 is positioned between the engine 100 and the second motor 300, and based on whether the clutch 400 is engaged, the HEV may be driven in an electric vehicle (EV) mode or an HEV mode.

A shift gear is provided in the transmission 500, and the torque output from the engine 100 and the second motor 300 to the wheels is changed according to the shift gear. For example, the transmission 500 may be implemented as an automatic transmission or a continuously variable transmission.

The battery 600, which is a high-voltage battery including a plurality of unit cells, may supply electric energy to the first motor 200 or the second motor 300 or may be charged with electric energy generated by each motor.

A vehicle-to-load (V2L) converter 700 may convert the high-voltage DC power of the battery 600 into low-voltage AC power used in general household appliances, such that the electric energy of the battery 600 can be used outside thereof.

An AC outlet 800 may be provided inside and outside the HEV to supply power to household appliances.

Meanwhile, the TMED type HEV may include a hybrid control unit (HCU) as an upper controller that controls overall operation. The TMED type HEV may further include an electronic control unit (ECU) that controls the engine 100. The TMED type HEV may further include a motor control unit (MCU) that controls the first motor 200 and the second motor 300. The TMED type HEV may further include a transmission control unit (TCU) that controls the transmission 500. The TMED type HEV may further include a battery management system (BMS) that controls the battery 600, and a traction control system (TCS) that prevents the driving wheels of a vehicle from slipping.

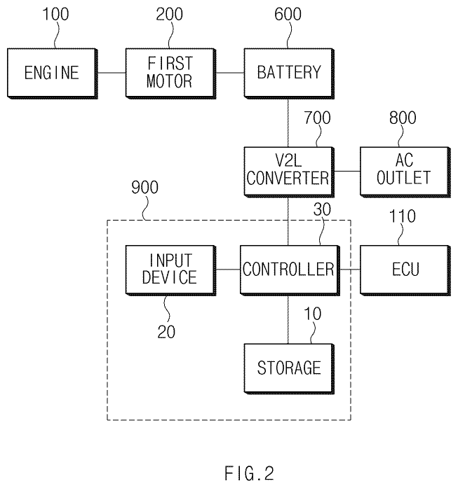

FIG. 2 is a block diagram illustrating the configuration of an apparatus for controlling a power generation mode of an HEV according to an embodiment of the present disclosure.

As illustrated in FIG. 2, an apparatus 900 for controlling a power generation mode of an HEV according to an embodiment of the present disclosure may include a storage 10, an input device 20, and a controller 30. In this case, depending on a scheme of implementing the apparatus 900 for controlling a power generation mode of an HEV according to an embodiment of the present disclosure, components may be combined with each other to be implemented as one component. Alternatively, some components may be omitted. In addition, for convenience, the first motor 200 is referred to as the motor 200 hereinafter.

Regarding each component, first, the storage 10 may store various logic, algorithms, and programs required in the process of receiving a setting of a power generation mode of the engine 100 from a user via the input device 200, supplying power to an alternating current (AC) outlet, and controlling an ECU 110 to operate the engine 100 of the HEV in the set power generation mode when a state of charge (SOC) of the battery 600 does not exceed a threshold value.

The storage 10 may store various logic, algorithms, and programs required in the process of including a brake specific fuel consumption (BSFC) map indicating an optimal operating line (OOL) of the engine 100, determining the efficiency of the converter 700, the efficiency of the battery 600, the efficiency of the motor 200, the required power of the AC outlet 800, the required power of the AC outlet 800 considering or based on the efficiency of the converter 700, and an amount of power corresponding to the SOC of the battery 600. The logic, algorithms, and programs may be required in the process of determining an operating point of the engine 100 based on the deviation from the required power of the AC outlet 800 when the SOC of the battery 600 is equal to or less than a threshold value. The logic, algorithms, and programs may be required in the process of determining the operating point of the engine 100 based on the OOL when the SOC of the battery 600 exceeds the threshold value and a reference operating point is located at the lower end of the OOL on the BSFC map. The logic, algorithms, and programs may be required in the process of determining the reference operating point as the operating point of the engine 100 when the reference operating point is located at the top of the OOL on the BSFC map.

The storage 10 may store various logic, algorithms, and programs required in the process of including the BSFC map indicating the OOL of the engine 100. The logic, algorithms, and programs may be required in the process of determining the efficiency of the converter 700, the efficiency of the battery 600, the efficiency of the motor 200, the efficiency (d1) of the engine 100 corresponding to an amount of fuel on the OOL, the required power (γ) of the AC outlet 800 considering or based on the efficiency of the converter 700, the efficiency (d2) of the engine 100 corresponding to the amount of fuel required to output γ, a chargeable energy amount (ξ) of the battery 600, the maximum efficiency (F) considering or based on ξ, and the partial efficiency (G) considering or based on γ. The logic, algorithms, and programs may be required in the process of determining the operating point of the engine 100 based on d1 on the BSFC map when F>G. The logic, algorithms, and programs may be required in the process of determining the operating point of the engine 100 based on d2 on the BSFC map when F<G.

The storage 10 may store various logic, algorithms, and programs required in the process of including the BSFC map in which a noise, vibration, harshness (NVH) optimal operating point is displayed on an OOL the engine 100. The logic, algorithms, and programs may be required in the process of determining the NVH optimal operating point of the engine 100 as the operating point when a user sets the power generation mode of the engine 100 to a low-noise mode. The logic, algorithms, and programs may be required in the process of determining the required power (γ) of the AC outlet 800 based on the efficiency of the converter 700 when the Soc of the battery 600 is equal to or less than the lower limit (e.g., 20%). The logic, algorithms, and programs may be required in the process of determining the operating point of the engine 100 as the operating point with the best efficiency (i.e., highest efficiency value) among the engine outputs corresponding to γ.

The storage 10 may store various logic, algorithms, and programs required in the process of including a BSFC map indicating an OOL of the engine 100. The logic, algorithms, and programs may be required in the process of determining the efficiency of the converter 700, the efficiency of the battery 600, the efficiency of the motor 200, the required power of the AC outlet 800, and AC maximum capacity (θ). The logic, algorithms, and programs may be required in the process of determining the operating point of the engine 100 for maximum power generation when a user sets the power generation mode of the engine 100 to a maximum mode. The logic, algorithms, and programs may be required in the process of determining a first operating point as the operating point of the engine 100 when a first condition is satisfied considering the chargeable power of the motor 200. The logic, algorithms, and programs may be required in the process of determining a second operating point as the operating point of the engine 100 when a second condition is satisfied considering or based on the chargeable power (λ) of the battery 600.

The input device 20 may receive the setting of the power generation mode of the engine 100 from the user. When the input device 20 is implemented as a touch screen, a screen for setting the power generation mode of the engine 100 may be displayed. For example, a screen may be displayed on the touch screen that allows selection of one of an automatic mode (i.e., first power generation mode), an optimal mode (i.e., second power generation mode), a low noise mode (i.e., third power generation mode), or a maximum mode (i.e., fourth power generation mode).

The controller 30 may be electrically connected to each component and may perform overall control such that each component performs its function. The controller 30 may be implemented in the form of hardware or software or may be implemented in a combination of hardware and software. In one example, the controller 30 may be implemented as a microprocessor, but is not limited thereto.

The controller 30 may receive a setting of the power generation mode of the engine 100 from the user through the input device 20. In other words, the controller 30 may receive a setting of one of the automatic mode, optimal mode, low noise mode, or maximum mode as the power generation mode of the engine 100. In this case, the automatic mode may be set as the default.

The controller 30 may operate the TMED type HEV in the power generation mode when the vehicle is stopped, the gear is in the P (Parking) position, and the electronic parking brake (EPB) is engaged.

The controller 30 may supply power to an AC outlet located inside and an AC outlet located outside of the TMED type HEV. The controller 30 may control the ECU 110 to operate the engine 100 of the HEV in the power generation mode set by the user when the SOC of the battery 600 does not exceed a threshold value.

The controller 30 may release the power generation mode when the user requests release of the power generation mode, when the unused time of the AC outlet exceeds a reference time (e.g., 10 minutes), when the AC connector of the device is disconnected from the AC outlet, or when the driver requests to start the engine 100. In this case, the controller 30 may release the power generation mode when the user permits the release after notifying the user of the release of the power generation mode.

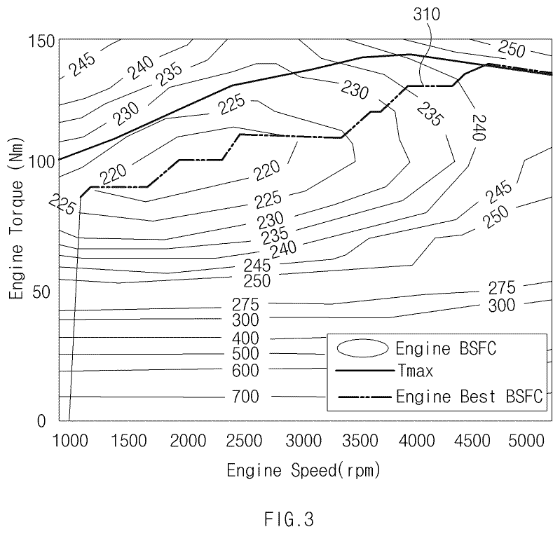

Hereinafter, with reference to FIG. 3, each operation performed by the controller 30 in various power generation modes is described in detail.

FIG. 3 is a diagram illustrating an example of a BSFC map of an engine stored in storage inside an apparatus for controlling a power generation mode of an HEV according to an embodiment of the present disclosure.

As illustrated in FIG. 3, the vertical axis represents engine torque, the horizontal axis represents engine RPM, and reference numeral 310 represents an OOL of the engine 100. In this case, the BSFC refers to the amount of fuel consumed per unit output, and the smaller the value of the BSFC, the higher the efficiency because the less fuel is consumed per output. In addition, the NVH optimal operating point may be further displayed on the OOL 310 of the engine 100.

When the automatic mode is set as the power generation mode of the engine 100, the controller 30 may determine the amount of power corresponding to the efficiency of the converter 700, the efficiency of the battery 600, the efficiency of the motor 200, the required power of the AC outlet 800, the required power of the AC outlet 800 considering or based on the efficiency of the converter 700, and the SOC of the battery 600. In this case, the controller 30 may be provided with an efficiency map of the converter 700, an efficiency map of the battery 600, and an efficiency map of the motor 200 and may determine each of efficiency based on them. For reference, the efficiency map of the converter 700, the efficiency map of the battery 600, and the efficiency map of the motor 200 are generally well-known in the art, and thus a detailed description has been omitted.

In addition, the controller 30 may determine the required power (γ) of the AC outlet 800 in which the efficiency of the converter 700 is reflected, based on the following Equation 1.

$$γ = \frac{β}{a} \qquad [ Equation 1 ]$$

In Equation 1, ‘β’ represents the required power of the AC outlet 800, and ‘a’ represents the efficiency of the converter 700. In this case, the required power of the AC outlet 800 means the required power of an electrical device connected to the AC outlet 800.

The controller 30 may determine the operating point of the engine 100 based on the deviation from the required power of the AC outlet 800 when the SOC of the battery 600 is equal to or less than a threshold value (e.g., 60%). For example, the controller 30 may determine the operating point (p) of the engine 100 based on the following Equation 2.

$$p = \frac{γ}{a b c} + \{ 1 + ( β - δ ) \} \qquad [ Equation 2 ]$$

In Equation 2, ‘a’ represents the efficiency of the converter 700, ‘b’ represents the efficiency of the battery 600, ‘c’ represents the efficiency of the motor 200, ‘γ’ represents the required power of the AC outlet 800 considering or based on the efficiency of the converter, ‘β’ represents the required power of the AC outlet 800, and ‘δ’ represents the amount of power corresponding to the SOC of the battery 600.

When the SOC of the battery 600 exceeds a threshold value (e.g., 60%), the controller 30 may determine the operating point of the engine 100 based on the OOL 310 when the reference operating point is located at a lower end of the OOL 310 on the BSFC map where the OOL 310 of the engine 100) is displayed as shown in FIG. 3, and the controller 30 may determine the reference operating point as the operating point of the engine 100 when the reference operating point is located at the upper end of the OOL 310. For example, the controller 30 may determine the reference operating point (p1) based on the following Equation 3.

$$p 1 = \frac{γ}{a b c} \qquad [ Equation 3 ]$$

The controller 30 may stop (turn OFF) the operation of the engine 100 when the SOC of the battery 600 reaches, for example, 70%.

When the optimal mode is set as the power generation mode of the engine 100, the controller 30 may determine the efficiency of the converter 700, the efficiency of the battery 600, the efficiency of the motor 200, the efficiency (d1) of the engine 100 corresponding to the amount of fuel on the OOL, the required power (γ) of the AC outlet 800 considering or based on the efficiency of the converter 700, the efficiency (d2) of the engine 100 corresponding to the amount of fuel (ε) required to output ‘γ’, the chargeable energy amount (ξ) of the battery 600, the maximum efficiency (F) considering or based on ξ, and the partial efficiency (G) considering or based on γ.

The controller 30 may determine the chargeable energy amount (ξ) of the battery 600, for example, based on the following Equation 4.

$$ζ = ( ε \times d 1 \times c - γ ) \times b \times a \qquad [ Equation 4 ]$$

In Equation 4, ‘γ’ represents the required power of the AC outlet 800 considering or based on the efficiency of the converter 700, ‘ε’ represents the amount of fuel required to output ‘γ’, ‘d1’ represents the efficiency of the engine 100 corresponding to the amount of fuel on the OOL, ‘a’ represents the efficiency of the converter 700, ‘b’ represents the efficiency of the battery 600, and ‘c’ represents the efficiency of the motor 200.

The controller 30 may determine the maximum efficiency (F) considering or based on ‘ξ’, for example, based on the following Equation 5.

$$F = ( \frac{ζ}{ζ + γ} \times d 1 \times c \times b \times a ) + ( \frac{γ}{ζ + γ} \times d 1 \times c \times a ) \qquad [ Equation 5 ]$$

In Equation 5, ‘a’ represents the efficiency of the converter 700, ‘b’ represents the efficiency of the battery 600, ‘c’ represents the efficiency of the motor 200, ‘d1’ represents the efficiency of the engine 100 corresponding to the amount of fuel on the OOL, ‘γ’ represents the required power of the AC outlet 800 considering or based on the efficiency of the converter 700, represents the efficiency of the engine corresponding to the amount of fuel required to output ‘γ’, and ‘ξ’ represents the chargeable energy amount of the battery 600.

The controller 30 may determine the partial efficiency (G), for example, based on the following Equation 6.

$$G = d 2 \times c \times a \qquad [ Equation 6 ]$$

In Equation 6, ‘d2’ represents the efficiency of the engine 100 corresponding to the amount of fuel (c) required to output γ.

The controller 30 may determine the operating point of the engine 100 by using ‘d1’ on the BSFC map when F>G, and the controller 30 may determine the operating point of the engine 100 by using ‘d2’ on the BSFC map when F<G.

When the low-noise mode is set as the power generation mode of the engine 100, the controller 30 may determine the NVH optimal operating point as the operating point of the engine 100.

When power generation is performed in the low-noise mode and the Soc of the battery 600 falls below the lower limit (e.g., 20%), the controller 30 may determine the required power (γ) of the AC outlet 800 considering or based on the efficiency of the converter 700, and the controller may determine the operating point with the best efficiency (i.e, highest efficiency value) among the engine outputs corresponding to ‘γ’ as the operating point of the engine 100. In this case, the engine output may be expressed as the product of engine torque and engine revolutions per minute (RPM), and the efficiency means the result of dividing the engine output by the amount of fuel.

When the maximum mode is set as the power generation mode of the engine 100, the efficiency of the converter 700, the efficiency of the battery 600, the efficiency of the motor 200, the required power of the AC outlet 800, and the AC maximum capacity may be determined. In this case, the AC maximum capacity means the maximum amount of power that may be able to be supplied to the AC outlet 800.

In addition, the controller 30 may determine the operating point (p2) of the engine 100 for maximum power generation based on the following Equation 7.

$$p 2 = \frac{θ}{a b c} \qquad [ Equation 7 ]$$

In Equation 7, ‘θ’ represents the maximum amount of power that is able to be supplied to the AC outlet 800.

When the controller 30 considers the chargeable power (κ) of the motor 200 in the maximum mode, and the first condition (e.g., κ<p2×c) is satisfied, the controller 30 may determine the operating point (p3) of the engine 100 based on the following Equation 8.

$$p 3 = \frac{κ}{c} \qquad [ Equation 8 ]$$

In Equation 8, ‘κ’ represents the chargeable power of the motor 200, and ‘c’ represents the efficiency of the motor 200.

When the controller 30 considers the chargeable power (λ) of the battery 600 in the maximum mode and the second condition (e.g., λ<(p2×c−β)×b) is satisfied, the controller 30 may determine the operating point (p4) of the engine 100 based on the following Equation 9.

$$p 4 = \frac{β}{c} + \frac{λ}{b c} \qquad [ Equation 9 ]$$

In Equation 9, ‘λ’ represents the chargeable power of the battery 600, ‘β’ represents the required power of the AC outlet 800, ‘b’ represents the efficiency of the battery 600, and ‘c’ represents the efficiency of the motor 200.

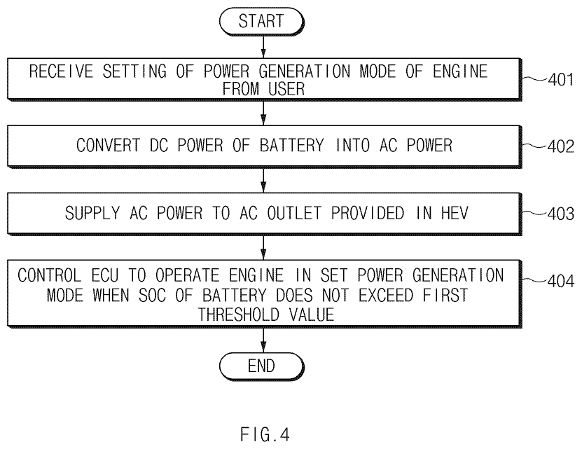

FIG. 4 is a flowchart illustrating a method of controlling a power generation mode of an HEV according to an embodiment of the present disclosure.

First, in operation or step 401, the input device 20 receives a setting of the power generation mode of the engine 100 from a user.

Then, in operation or step 402, the converter 700 converts DC power of the battery 600 into AC power.

Then, in operation or step 403, the controller 30 supplies the AC power to the AC outlet provided in the HEV.

Then, when the SOC of the battery 600 does not exceed the first threshold value, in operation or step 404, the controller 30 controls the ECU 110 to operate the engine 100 in the set power generation mode.

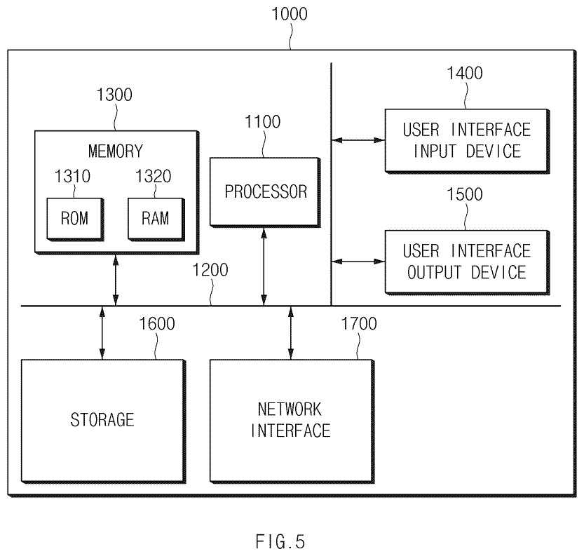

FIG. 5 is a block diagram illustrating a computing system for executing a method of controlling a power generation mode of an HEV according to the embodiments of the present disclosure.

Referring to FIG. 5, as described above, the method of controlling a power generation mode of an HEV according to an embodiment of the present disclosure may be implemented through a computing system 1000. The computing system 1000 may include at least one processor 1100, a memory 1300, a user interface input device 1400, a user interface output device 1500, a storage 1600, and a network interface 1700, which are connected through a system bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the processes of the method or algorithm described in relation to the embodiments of the present disclosure may be implemented directly by hardware executed by the processor 1100, a software module, or a combination thereof. The software module may reside in a storage medium (i.e., the memory 1300 and/or the storage 1600), such as a RAM, a flash memory, a ROM, an EPROM, an EEPROM, a register, a hard disk, a detachable disk, or a CD-ROM. The storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

According to the embodiments, it is possible to provide various power generation modes that may satisfy the needs of a user and may increase the operating efficiency of an engine to prevent unnecessary waste of energy. To this end, the apparatus and the method may receive a setting of an engine power generation mode from a user, may supply power to an alternating current (AC) outlet, and may control an engine control unit (ECU) to operate the engine of a hybrid electric vehicle (HEV) in the set power generation mode when a state of charge (SOC) of a battery does not exceed a threshold value.

What is claimed is:

1. An apparatus for controlling a power generation mode of a hybrid electric vehicle (HEV), the apparatus comprising:
an input device configured to receive a setting of the power generation mode of an engine from a user;
a converter configured to convert direct current (DC) power of a battery into alternating current (AC) power; and
a controller configured to:
supply the AC power to an AC outlet provided in the HEV; and
control an engine control unit (ECU) to operate the engine in the set power generation mode when a state of charge (SOC) of a battery does not exceed a first threshold value.

2. The apparatus of claim 1, wherein the input device is configured to receive a setting of one of an automatic mode, an optimum mode, a low noise mode, or a maximum mode as the power generation mode.

3. The apparatus of claim 2, wherein the controller is configured to determine an operating point of the engine based on an efficiency of the converter, an efficiency of the battery, an efficiency of a motor directly connected to the engine, a required power of the AC outlet, a required power of the AC outlet reflecting the efficiency of the converter, and an amount of power corresponding to the Soc of the battery when the SOC of the battery does not exceed the first threshold value.

4. The apparatus of claim 2, wherein the controller is configured to:
determine an operating point of the engine based on an efficiency of the converter, an efficiency of the battery, an efficiency of a motor directly connected to the engine, and a required power of the AC outlet reflecting the efficiency of the converter when the SOC of the battery exceeds the first threshold value due to an operation of the engine; and
stop the operation of the engine when the SOC of the battery exceeds a second threshold value due to the operation of the engine.

5. The apparatus of claim 2, wherein the controller is configured to:
determine a maximum efficiency based on a chargeable energy amount of the battery;
determine a partial efficiency based on a required power of the AC outlet, wherein in the AC outlet, an efficiency of the converter is reflected;
determine an operating point of the engine based on a brake specific fuel consumption (BSFC) map indicating an optimal operating line (OOL) of the engine when the maximum efficiency exceeds the partial efficiency; and
determine the operating point of the engine based on an efficiency of the engine corresponding to an amount of fuel required to output the required power of the AC outlet, when the maximum efficiency does not exceed the partial efficiency.

6. The apparatus of claim 2, wherein the controller is configured to determine an operating point of the engine based on a brake specific fuel consumption (BSFC) map indicating an optimal operating line (OOL) and a noise, vibration, harshness (NVH) optimal operating point of the engine.

7. The apparatus of claim 6, wherein the controller is configured to:
determine a required power of the AC outlet based on an efficiency of the converter when the SOC of the battery reaches a low limit value; and
determine an operating point having a highest efficiency among engine outputs corresponding to the required power as the operating point of the engine.

8. The apparatus of claim 2, wherein the controller is configured to determine an operating point of the engine based on an efficiency of the converter, an efficiency of the battery, an efficiency of a motor directly connected to the engine, and a maximum amount of power supplied to the AC outlet when the maximum mode is set as the power generation mode.

9. The apparatus of claim 2, wherein the controller is configured to determine an operating point of the engine based on a chargeable power and an efficiency of a motor directly connected to the engine when the maximum mode is set as the power generation mode.

10. The apparatus of claim 2, wherein the controller is configured to determine an operating point of the engine based on a charging power and an efficiency of the battery, an efficiency of a motor directly connected to the engine, and a required power of the AC outlet when the maximum mode is set as the power generation mode.

11. A method of controlling a power generation mode of a hybrid electric vehicle (HEV), the method comprising:
receiving, by an input device, a setting of the power generation mode of an engine from a user;
converting, by a converter, direct current (DC) power of a battery into alternating current (AC) power;
supplying, by a controller, the AC power to an AC outlet provided in the HEV; and
controlling, by the controller, an engine control unit (ECU) to operate the engine in the set power generation mode when a state of charge (SOC) of a battery does not exceed a first threshold value.

12. The method of claim 11, wherein receiving the setting of the power generation mode of the engine includes receiving a setting one of an automatic mode, an optimum mode, a low noise mode, or a maximum mode.

13. The method of claim 12, wherein controlling the ECU includes determining an operating point of the engine based on an efficiency of the converter, an efficiency of the battery, an efficiency of a motor directly connected to the engine, a required power of the AC outlet, a required power of the AC outlet reflecting the efficiency of the converter, and an amount of power corresponding to the SOC of the battery when the SOC of the battery does not exceed the first threshold value.

14. The method of claim 12, wherein controlling the ECU includes:
determining an operating point of the engine based on an efficiency of the converter, an efficiency of the battery, an efficiency of a motor directly connected to the engine, and a required power of the AC outlet reflecting the efficiency of the converter when the SOC of the battery exceeds the first threshold value due to an operation of the engine; and
stopping the operation of the engine when the SOC of the battery exceeds a second threshold value due to the operation of the engine.

15. The method of claim 12, wherein controlling the ECU includes:
determining a maximum efficiency based on a chargeable energy amount of the battery;
determining a partial efficiency based on a required power of the AC outlet, wherein in the AC outlet, an efficiency of the converter is reflected;
determining an operating point of the engine based on a brake specific fuel consumption (BSFC) map indicating an optimal operating line (OOL) of the engine when the maximum efficiency exceeds the partial efficiency; and
determining the operating point of the engine based on an efficiency of the engine corresponding to an amount of fuel required to output the required power of the AC outlet, when the maximum efficiency does not exceed the partial efficiency.

16. The method of claim 12, wherein controlling the ECU includes determining an operating point of the engine based on a brake specific fuel consumption map indicating an optimal operating line (OOL) and a noise, vibration, harshness (NVH) optimal operating point of the engine.

17. The method of claim 16, wherein controlling the ECU further includes:
determining a required power of the AC outlet based on an efficiency of the converter when the SOC of the battery reaches a low limit value; and
determining an operating point having a highest efficiency among engine outputs corresponding to the required power as the operating point of the engine.

18. The method of claim 12, wherein controlling the ECU includes determining an operating point of the engine based on an efficiency of the converter, an efficiency of the battery, an efficiency of a motor directly connected to the engine, and a maximum amount of power supplied to the AC outlet when the maximum mode is set as the power generation mode.

19. The method of claim 12, wherein controlling the ECU includes determining an operating point of the engine based on a chargeable power and an efficiency of a motor directly connected to the engine when the maximum mode is set as the power generation mode.

20. The method of claim 12, wherein controlling the ECU includes determining an operating point of the engine based on a charging power and an efficiency of the battery, an efficiency of a motor directly connected to the engine, and a required power of the AC outlet when the maximum mode is set as the power generation mode.
